(19) United States
(12) Patent Application Publication
(10) Pub. No.: US 2014/0379578 A1
(43) Pub. Date: Dec. 25, 2014

(54) METHOD AND SYSTEM FOR CONDUCTING ON-BEHALF ELECTRONIC FINANCIAL TRANSACTION

(71) Applicant: MasterCard International Incorporated, Purchase, NY (US)

(72) Inventors: David Chan, Singapore (SG); Manohar Murali, Singapore (SG); Rajen S. Prabhu, Singapore (SG); Sandeep Malhotra, Singapore (SG)

(21) Appl. No.: 14/300,711

(22) Filed: Jun. 10, 2014

(30) Foreign Application Priority Data
Jun. 20, 2013 (SG) 201304828-5

(51) Int. Cl. G06Q 20/32; G06Q 20/40; G06Q 20/10

(52) U.S. Cl. CPC G06Q 20/322; G06Q 20/10; G06Q 20/4012
USPC 705/44

(57) ABSTRACT

A method of conducting an electronic financial transaction over a payment network on behalf of a customer is provided using a payment application stored in a mobile device of a facilitator, the method including: receiving transaction details of the electronic financial transaction in the payment application from the customer; generating a transaction request for the electronic financial transaction based on said the transaction details received; and forwarding the transaction request to a payment gateway for processing to carry out the electronic financial transaction over the payment network, the payment gateway having stored therein account details of a payment card linked to the facilitator from which funds are authorized to be deducted or to which funds are authorized to be credited based on the transaction request to pay for or receive funds from the electronic financial transaction on behalf of the customer in exchange for the facilitator receiving cash payment from or providing cash to the customer. There is also provided a system for conducting an electronic financial transaction on behalf of a customer, and a computer program product, embodied in a non-transitory computer-readable storage medium, including instructions executable by a computing processor to perform the above method.

### CROSS-REFERENCE TO RELATED APPLICATION

This application is a U.S. National Stage filing under 35 U.S.C. §119, based on and claiming benefit of and priority to SG Patent Application No. 201304828-5 filed Jun. 20, 2013.

### FIELD OF DISCLOSURE

The present disclosure relates generally to a method of conducting on-behalf electronic financial transaction, more particularly, conducting an electronic financial transaction on behalf of a customer, such as a payment transaction on behalf of a customer seeking to make cash payment for an item of goods and/or services, or a funding transaction on behalf of a customer seeking to make a fund transfer to a recipient or seeking to make a cash-out transaction.

### BACKGROUND

Consumers are undergoing financial stress, resulting in higher levels of late payments and increased credit risk exposures. Banks have increased credit risk exposure, and are reluctant to take on credit risk in a tightened regulatory environment with limits on overdraft fees. In most emerging markets, due to high instance of frauds, Know Your Customer (KYC) and Anti-Money Laundering (AML) standards are stringent. At the same time, the absence of credit bureau and centralized KYC databases makes it expensive for banks to issue no frills or prepaid accounts to consumers.

The rising unbanked (or under-banked) portion of the customer base in countries such as India, Indonesia and Vietnam represents a problem for merchants. As e-commerce and electronic bill payments grow competitive, the unbanked population provides a growth opportunity for merchants. As a consequence, several markets such as India have seen e-commerce growth only with the introduction of cash on delivery (COD) options for buying consumers. Given the risks and costs associated with COD (e.g., consumer unavailable at home, not having adequate cash, need to manage shrinkage from a distributed vendor network), this option has been expensive.

The growth of e-commerce and bill payments in markets with significant unbanked population requires that billers and merchants make it easy to collect payments from this population in a manner that ensures efficient processing. Historically, for example in the U.S., the unbanked consumers have made heavy use of money orders, one of the most expensive forms of payment. In developing markets, because many unbanked consumers pay their bills at the last minute, they often have to pay a surcharge to expedite the transactions in order to meet the due date. Given the preference this population has for cash transactions as well as the segment's aversion to bank accounts, a common bill payment channel is walk-in. Unfortunately for merchants, this is a high-touch, high-cost channel for accepting payments for their goods/services.

A need therefore exists to provide an improved method of conducting an electronic financial transaction on behalf of customers, including unbanked (or under-banked) customers, that seeks to address at least the above-mentioned problems.

### SUMMARY

According to a first aspect of the present disclosure, there is provided a method of conducting an electronic financial transaction over a payment network on behalf of a customer using a payment application stored in a mobile device of a facilitator, the method comprising:
receiving transaction details of the electronic financial transaction in the payment application from the customer;
generating a transaction request for the electronic financial transaction based on the transaction details received; and
forwarding the transaction request to a payment gateway for processing to carry out the electronic financial transaction over the payment network, the payment gateway having stored therein account details of a payment card linked to the facilitator from which funds are authorized to be deducted or to which funds are authorized to be credited based on the transaction request to pay for or receive funds from the electronic financial transaction on behalf of the customer in exchange for the facilitator receiving cash payment from or providing cash to the customer.

Preferably, the method further comprises:
receiving an authentication code from the facilitator, and
forwarding the authentication code to the payment gateway for verifying the identity of the facilitator prior to the payment gateway executing the transaction request,
wherein the payment gateway having further stored therein a predetermined authentication code linked to the payment application for verification against the received authentication code.

Preferably, the authentication code is a personal identification number (PIN) of the facilitator.

Preferably, the payment card is a debit card, a credit card or a prepaid card, and the account details linked to the facilitator comprise a debit card number, a credit card number, or a prepaid card number and an expiry date.

In an embodiment, the electronic financial transaction comprises a payment transaction on behalf of the customer for an item of goods and/or services, and the transaction details received comprise details of the item of goods and/or services.

Preferably, said details of the item comprise information indicative of a biller or a merchant of the item and a payment amount.

Preferably, the payment application is operable to provide a list of participating billers or merchants for accepting payments through the payment application.

Preferably, a plurality of the payment cards is issued for an entity managing or owning a distribution network comprising a plurality of the facilitators, each facilitator being respectively linked with account details of a unique one of the plurality of payment cards from which funds are authorized to be deducted based on the transaction request to pay for the item on behalf of the customer in exchange for the facilitator receiving cash payment from the customer.

Preferably, the entity is one of a telecommunications company, an insurance company, a post office, a ticketing company and a convenience store.

Preferably, the item of goods and/or services is displayed on an online merchant's website, and the website is configured to provide a checkout option for accepting payment through the facilitator.

Preferably, an acceptance mark is displayed on the website for informing the customer of the possibility of making payment through the facilitator.

Preferably, upon checkout, the website is configured to provide the customer with a payment voucher comprising information indicative of said details of the item of goods and/or services to be supplied to the facilitator for conducting the electronic payment transaction, the payment voucher being in the form of an electronic document and/or an electronic code comprising said details of the item.

In another embodiment, the electronic financial transaction comprises a funding transaction on behalf of the customer for a fund transfer from the customer to a recipient, and the transaction details received comprise details of the recipient and a transfer amount.

In yet another embodiment, the electronic financial transaction comprises a funding transaction on behalf of the customer for a cash-out transaction, and the transaction details received comprise details of the customer and a cash-out amount.

According to a second aspect of the present disclosure, there is provided a system for conducting an electronic financial transaction over a payment network on behalf of a customer, the system comprising:
a mobile device having stored therein a payment application for a facilitator to conduct the electronic financial transaction, the mobile device, under control of the payment application when executed, is operable to receive transaction details of the electronic financial transaction and generate a transaction request for the electronic financial transaction based on said the transaction details received; and
a payment gateway operable to receive and process the transaction request, the payment gateway having stored therein account details of a payment card linked to the facilitator from which funds are authorized to be deducted or to which funds are authorized to be credited based on the transaction request to pay for or receive funds from the electronic financial transaction on behalf of the customer in exchange for the facilitator receiving cash payment from or providing cash to the customer.

Preferably, the mobile device is operable to prompt the facilitator to input an authentication code, and forward the received authentication code to the payment gateway for verifying the identity of the facilitator prior to the payment gateway executing the transaction request, and
wherein the payment gateway is operable to store a predetermined authentication code linked to the payment application for verification against the received authentication code.

Preferably, the authentication code is a personal identification number (PIN) of the facilitator.

Preferably, the payment card is a debit card, a credit card, or a prepaid card and the account details linked to the facilitator comprise a debit card number, a credit number, or a prepaid card number, and an expiry date.

In an embodiment, the electronic financial transaction comprises a payment transaction on behalf of the customer for an item of goods and/or services, and the transaction details received comprise details of the item of goods and/or services.

Preferably, said details of the item comprise information indicative of a biller or a merchant of the item and a payment amount.

Preferably, the mobile device is operable to provide a list of participating billers or merchants for accepting payments through the payment application.

Preferably, a plurality of the payment cards is issued for an entity managing or owning a distribution network comprising a plurality of the facilitators, each facilitator being respectively linked with account details of a unique one of the plurality of payment cards from which funds are authorized to be deducted based on the transaction request to pay for the item on behalf of the customer in exchange for cash payment from the customer.

Preferably, the entity is one of a telecommunications company, an insurance company, a post office, a ticketing company and a convenience store.

Preferably, the item of goods and/or services is displayed on an online merchant's website, and the website is configured to provide a checkout option to accept payment through the facilitator.

Preferably, an acceptance mark is displayed on the website for informing the customer of the possibility of making payment through the facilitator.

Preferably, upon checkout, the website is configured to provide the customer with a payment voucher comprising information indicative of said details of the item of goods and/or services to be supplied to the facilitator for conducting the electronic payment transaction, the payment voucher being in the form of an electronic document and/or an electronic code comprising said details of the item.

In another embodiment, the electronic financial transaction comprises a funding transaction on behalf of the customer for a fund transfer from the customer to a recipient, and the transaction details received comprise details of the recipient and a transfer amount.

In yet another embodiment, the electronic financial transaction comprises a funding transaction on behalf of the customer for a cash-out transaction, and the transaction details received comprise details of the customer and a cash-out amount.

According to a third aspect of the present disclosure, there is provided a computer program product, embodied in a non-transitory computer-readable storage medium, comprising instructions executable by a computing processor to perform the method according to the first aspect of the present disclosure described hereinbefore.

### BRIEF DESCRIPTION OF THE DRAWINGS

Embodiments of the present disclosure will be better understood and readily apparent to one of ordinary skill in the art from the following written description, by way of example only, and in conjunction with the drawings, in which:

FIG. 1 depicts an exemplary mobile device according to an embodiment of the present disclosure;

FIG. 2 depicts a broad overview of an electronic payment transaction system for conducting payment transaction on behalf of a customer according to an exemplary embodiment of the present disclosure;

FIG. 3 depicts an exemplary overview of the inter-relationship between various parties involved in the on-behalf electronic payment transaction;

FIG. 4 depicts various parties involved in the payment program according to an embodiment of the present disclosure;

FIG. 5 depicts a flow diagram of a method of conducting an electronic payment transaction using a payment application according to an embodiment of the present disclosure;

FIGS. 6A to 6F illustrate an exemplary user interface of the payment application displayed at various stages of the payment transaction according to an embodiment of the present disclosure;

FIGS. 7A to 7K illustrate another exemplary user interface of the payment application displayed at various stages of the payment transaction according to another embodiment of the present disclosure;

FIG. 8 depicts a broad overview of conducting an electronic payment transaction with an online merchant according to an embodiment of the present disclosure;

FIGS. 9A to 9C illustrate exemplary screenshots of a merchant's website at various stage of purchasing an item;

FIG. 10A depicts an exemplary user interface of the payment application when scanning a QR code;

FIG. 10B depicts an exemplary user interface of the payment application displaying the transaction details for confirmation;

FIG. 10C depicts an exemplary confirmation message received on a customer's mobile phone that the payment has been received and the purchased item will be dispatched;

FIGS. 11A to 11C depict three exemplary configurations of an electronic funding transaction system for conducting a funding transaction on behalf of a customer according to exemplary embodiments of the present disclosure;

FIGS. 12A to 12E depict an exemplary user interface of the payment application displayed at various stages of the funding transaction according to an embodiment of the present disclosure; and

FIGS. 13A to 13C depict three exemplary configurations of an electronic funding transaction system for a cash-out transaction for a customer according to exemplary embodiments of the present disclosure.

### DETAILED DESCRIPTION

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses an apparatus or device for performing the operations of the methods. Such apparatus or device may be specially constructed for the required purposes, or may comprise other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate.

In addition, the present specification also implicitly discloses a computer program (including a mobile application for a mobile device), in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program that can use different control flows without departing from the spirit or scope of the disclosure.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer or a mobile device. The computer readable medium may also include a hard-wired medium such as exemplified in the Internet system, or wireless medium such as exemplified in the GSM or LTE mobile network technology. The computer program when loaded and executed on such a computer or mobile device effectively results in an apparatus or device that implements the steps of the preferred method.

The present disclosure may also be implemented as hardware modules. More particular, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the system can also be implemented as a combination of hardware and software modules.

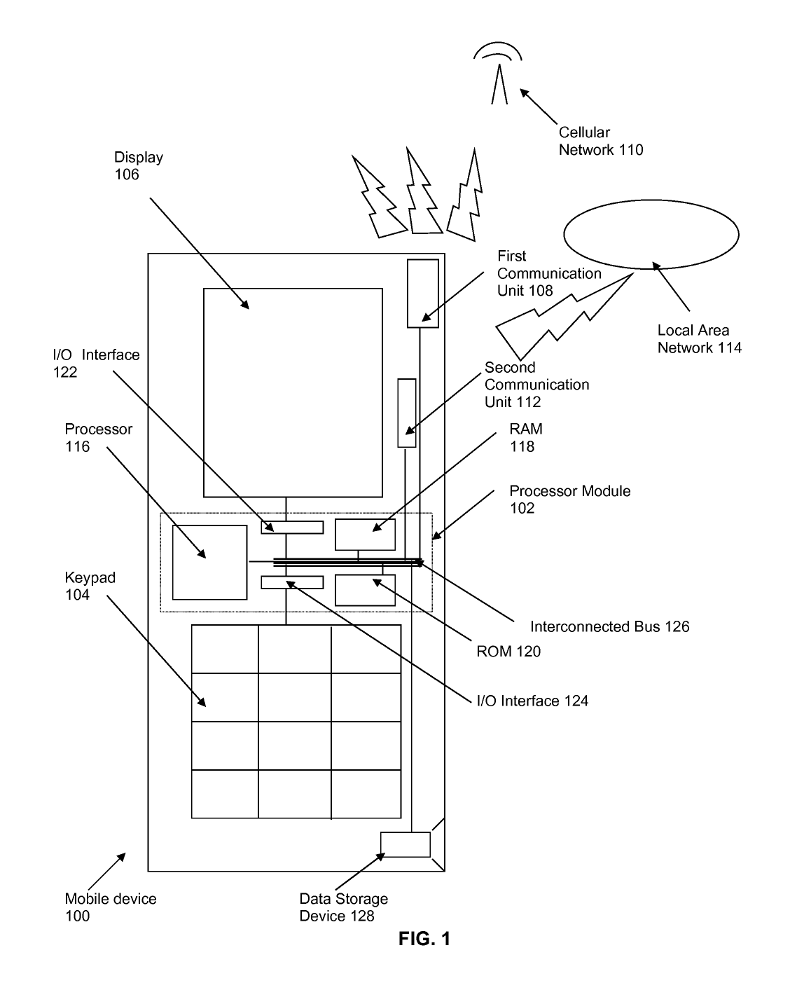

According to an exemplary embodiment, the method described herein is implemented on a mobile device 100, schematically shown in FIG. 1 as an example only. It will be appreciated to a person skilled in the art that although the mobile device 100 is depicted as a mobile phone in FIG. 1 and other figures, the mobile device 100 is not limited to a mobile phone. For example, the mobile device 100 may be a smartphone (e.g., an Apple iPhone® or BlackBerry®), a laptop, a personal digital assistant (PDA), a tablet computer, and/or the like. The method may be implemented as software, such as a computer program (e.g., a mobile application) being executed within the mobile device 100, and instructing the mobile device 100 to conduct a method of the example embodiment.

The mobile device 100 comprises a processor module 102, an input module such as a keypad 104 and an output module such as a display 106. It will be appreciated to a person skilled in the art that the input module does not necessary require a keypad 104. For example, the input module can be in the form of a touchscreen, such as a touchscreen display. The processor module 102 is coupled to a first communication unit 108 for communication with a cellular network 110. The first communication unit 108 can include, but is not limited to, a subscriber identity module (SIM) card loading bay. The cellular network 110 can, for example, be a 3G or 4G network. The processor module 102 is further coupled to a second communication unit 112 for connection to a local area network 114. For example, the connection can enable wired/wireless communication and/or access to a network system, such as the Internet or other network systems, such as Local Area Network (LAN), Wireless Personal Area Network (WPAN) or Wide Area Network (WAN). The second communication unit 112 can include, but is not limited to, a wireless network card or an Ethernet network cable port. The processor module 102 in the example includes a processor 116, a Random Access Memory (RAM) 118 and a Read Only Memory (ROM) 120. The processor module 102 also includes a number of Input/Output (I/O) interfaces, for example I/O interface 122 to the display 106, and I/O interface 124 to the keypad 104. The components of the processor module 102 typically communicate via an interconnected bus 126 and in a manner known to the person skilled in the relevant art.

The mobile applications (or “apps”) may be supplied to the user of the mobile device 100 encoded on a data storage medium such as a flash memory module or memory card/stick and read utilising a corresponding memory reader-writer of a data storage device 128. The mobile application is read and controlled in its execution by the processor 116. Intermediate storage of program data may be accomplished using RAM 118. With current state-of-the-art smartphones, mobile applications are typically downloaded onto the mobile device 100 wirelessly through digital distribution platforms, such as iOS App Store and Android Google Play. As known in the art, mobile applications executable by a mobile device may be created by a user for performing various desired functions using Software Development Kits (SDKs) or the like, such as Apple iPhone® iOS SDK or Android® OS SDK.

According to exemplary embodiments of the present disclosure, a method of conducting an electronic financial transaction over a payment network on behalf of a customer is provided using an application (e.g., payment application) stored in a mobile device of a facilitator. In a first embodiment, the electronic financial transaction comprises a payment transaction on behalf of the customer for an item of goods and/or services. In a second embodiment, the electronic financial transaction comprises a funding transaction on behalf of the customer. For example, the funding transaction may be for a fund transfer from the customer to a recipient, or for a cash-out transaction for the customer.

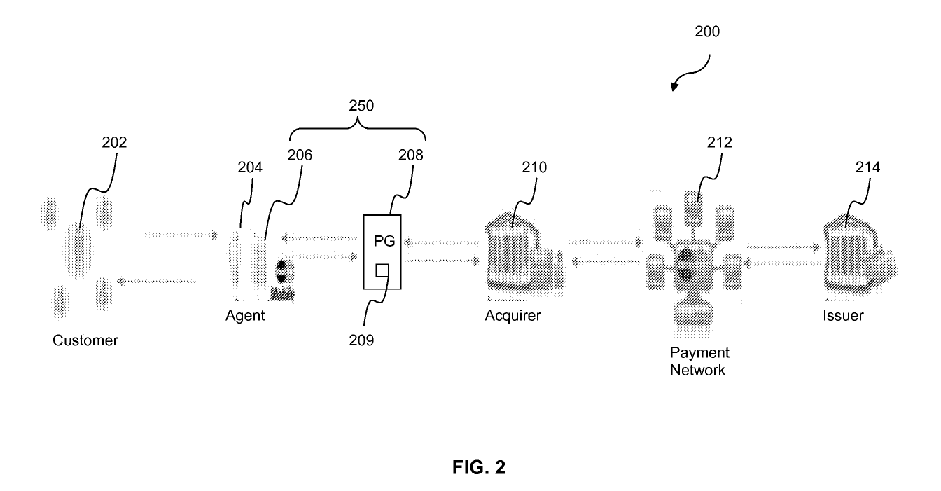

A broad overview of an electronic payment transaction system 200 for conducting payment transaction on behalf of a customer 202 according to the first embodiment of the present disclosure is shown in FIG. 2. In the exemplary embodiment, the customer 202 may be unbanked or simply wishes to make cash payment for an item of merchant's goods and/or services. For example, the item may be mobile or utility bills, railway or airline tickets, top-up mobile airtime, and/or online purchases. To make the cash payment for the item, the customer 202 visits a facilitator (e.g., an agent) 204 who is able to conduct the on-behalf electronic payment transaction. In particular, the facilitator 204 is equipped with a mobile device 206 having a payment application installed therein according to an embodiment of the present disclosure. Preferably, the facilitator 204 is available at various convenient locations (e.g., a kiosk, a convenient store, a post office, and/or the like). The facilitator 204 receives the necessary details to conduct the payment transaction (e.g., name of merchant, customer account number, mobile phone number, and payment amount) from the customer 202 and enters the details to the payment application to make a payment transaction request on behalf of the customer 202. The payment application sends the payment transaction request containing the details to a payment gateway 208 such as the MasterCard Payment Gateway operated by MasterCard International Incorporated) for processing. When making the payment transaction request, the facilitator 204 is also required to enter an authentication code (e.g., a PIN) for authentication with the payment gateway 208.

Upon successfully authenticating the facilitator 204, the payment gateway 208 executes/processes the payment transaction request received. In particular, the payment gateway 208 generates and forwards a payment authorization request to the participating acquirer 210. Preferably, the payment authorization request conforms to an International Organization for Standardization (ISO) standard for systems that exchange electronic transactions using payment cards, such as, ISO-8583. The acquirer 210 receives the payment authorization request and forwards it to a payment network 212 (such as the payment network operated by MasterCard International Incorporated). The payment network 212 processes the payment authorization request and forwards it to a participating issuer 214 for authorization. The issuer 214 generates an issuer response indicating whether the payment authorization request has been approved. The issuer 214 sends the issuer response to the acquirer 210 through the payment network 212. The acquirer 210 receives and forwards the issuer response to the payment gateway 208, and the payment gateway 208 in turn communicates the issuer response to the mobile device 206 of the facilitator 204. The facilitator 204 will then provide a transaction receipt to the customer 202 indicative of the outcome of the payment transaction request. If the payment transaction request is successful, the facilitator 204 collects cash payment from the customer 202 to cover for the cost of the item, along with any service fees. Alternatively, to minimize risk of insufficient cash payment, the facilitator 204 may collect cash payment from the customer 202 prior to making the payment transaction.

In the exemplary embodiment, the payment application installed in the facilitator's mobile device 206 is linked to the account details of a payment card (e.g., a debit card, a credit card, or a prepaid card) associated or linked to the facilitator 204 from which funds are authorized to be deducted based on the payment transaction request to pay for the item of goods and/or services on behalf of the customer 202 in exchange for the facilitator 204 receiving cash payment from the customer 202. For example, payment card details include debit/credit/prepaid card number, expiry date, and card verification/validation value/code (e.g., CVV or CVC). Accordingly, the exemplary embodiment is advantageously able to convert cash or unbanked bill payments to payment card (e.g., credit, debit or prepaid) transactions to, e.g., serve markets with significant unbanked customers.

The exemplary embodiment provides customers 202 with a fast, convenient, secure and low-cost option of making cash payment for an item of good and/or services. For example, the merchant may not offer a cash payment option or may not have any payment collection locations convenient for the customer 202 to visit. According to the exemplary embodiment, the facilitators 204 (enabled by their mobile device 206 having the payment application) form a large payment collection network, thereby providing customers 202 with ample possible locations to make cash payments. The exemplary embodiment also advantageously reduce payment collection costs for merchants (e.g., they may reduce or eliminate the need to provide their own physical locations for the purpose of collecting cash payments) and/or provide an opportunity for the merchants to make additional revenue (e.g., the merchant may monetize its agent network by offering payment collection services on behalf of other merchants through the payment application and charging an appropriate service fee).

Various operations/functions of the parties/entities involved in the on-behalf electronic payment transaction (payment program) according to exemplary embodiments of the present disclosure will be described in further details below.

According to an exemplary embodiment, the payment gateway 208, e.g., in the form of a computer server, functions as an interface for processing payment transaction requests from the payment applications. This includes authenticating the identity of the facilitator 204, and if the authentication is successful, generating and forwarding a payment authorization request (based on the transaction details entered by the facilitator 204 in the payment application) to the acquirer 210.

The payment gateway 208 comprises a data storage medium 209 operable to store the unique identification number of each payment application registered/enrolled with the payment gateway 208 to conduct the on-behalf payment transaction. The storage medium 209 also stores the authentication code (e.g., a PIN) set by the facilitator 204 for each payment application. When making a payment transaction request using the payment application, the payment application is operable to prompt the facilitator 204 to enter an authentication code for verifying his/her identity 204 (i.e., whether the facilitator 204 is an authorized user of the payment application). The authentication code entered by the facilitator 204 is compared with the authentication code stored in the payment gateway 208 for the payment application linked/associated with the facilitator 204. If the authentication code entered by the facilitator 204 matches that stored in the payment gateway 208, the payment transaction request initiated by the payment application is approved and the payment gateway 208 proceeds to generate the payment authorization request as described above. The storage medium 209 is further operable to store account details of the payment card linked to each payment application. Therefore, upon successful authentication of each payment transaction request, the account details linked to the payment application will be used as a source of funds for the payment transaction. For example, the payment authorization request forwarded to the acquirer 210 for processing may include transaction details (e.g., name of merchant, customer account number, and payment amount), account details (e.g., credit/debit/prepaid card number, expiry date, CVC), and authentication token (as an indication that the facilitator 204 making the payment transaction request has been successfully authenticated).

According to an exemplary embodiment, the facilitator (e.g., agent) 204 is preferably part of a wide distribution/agent network owned or managed by an entity (e.g., a company or an organization). The entity is a participant of the payment program and is responsible for managing and equipping facilitators 204 of its distribution network with the payment application and if necessary the mobile device 206. This includes enrolling the payment application used by each facilitator 204 on the payment gateway 208. For example, the entity may be a mobile network operator (MNO), a post office, a convenient store and/or a payment aggregator. The entity is also responsible for obtaining payment cards from the issuer bank 214 (with collateral and limits set by the entity), such as in the form of a corporate card program. The payment application of each facilitator 204 of the entity's distribution network is linked to a payment card (preferably a unique payment card) issued for the entity in the payment gateway 208. Therefore, upon successful authorization for a payment transaction request, funds can be withdrawn against the payment card account of the facilitator 204 to pay for an item of goods and/or services on behalf of a customer 202 making cash payment.

The payment application advantageously enables the entity to launch low-cost electronic acceptance solutions for their walk-in customer. In particular, it enables the entity to monetize their distribution/agent network for enabling more transactions across a large network of merchants, as well as manage to service a large number of unbanked/under-banked consumers without necessarily selling them a new product/service. For example, the entity may use the payment application not only to collect payments for their own goods/services, but also for goods/services of other merchants who are participating in the payment program in exchange for an appropriate service fee.

According to an exemplary embodiment, the biller/merchant aggregator is responsible for managing and maintaining its own biller/merchant network that offers the payment program. In particular, the merchant aggregator recruits merchants to participate in the payment program and to join its network. The participating merchants will appear in the payment application as a list of billers/merchants who accept payments through the payment program. The merchant aggregator integrates its front-end user interface (UI) server with the payment gateway 208 such that its merchant network will appear in the payment application for accepting payments. In this regard, the merchant aggregator assists the acquirer 210 to enroll details of participating merchants on the payment gateway 208. In addition, based on transaction confirmation received from the payment gateway 208, the merchant aggregator advises its merchant network (e.g., for settlement and for transaction fulfillment) and the facilitator 204 (e.g., outcome of the transaction) accordingly. The merchant aggregator may also deploy a payment program acceptance mark on participating merchant websites so as to inform customers 202 of the availability of this payment option.

According to an exemplary embodiment, the acquirer bank 210 enrolls participating merchant details on the payment gateway 208 and communicates with the payment gateway 208 for processing payment transaction requests from the payment gateway 208. The acquirer bank 210 advises the payment gateway 208 of the transaction authorization status for onward confirmation to the facilitator 204. The acquirer bank 210 also clears and settles payment transactions with the payment network 212.

According to an exemplary embodiment, the issuer bank 214 issues payment cards to entities (e.g., companies/organizations) as described hereinbefore. The issuer 214 may also enroll the facilitators' payment applications for the entity on the payment gateway 208, along with the corresponding payment card account linked to each payment application. The issuer 214 also shares an authentication value generation key with the payment gateway 208 for authenticating the payment transaction request from the facilitator 204. The issuer bank 210 also authorizes and clears payment transactions.

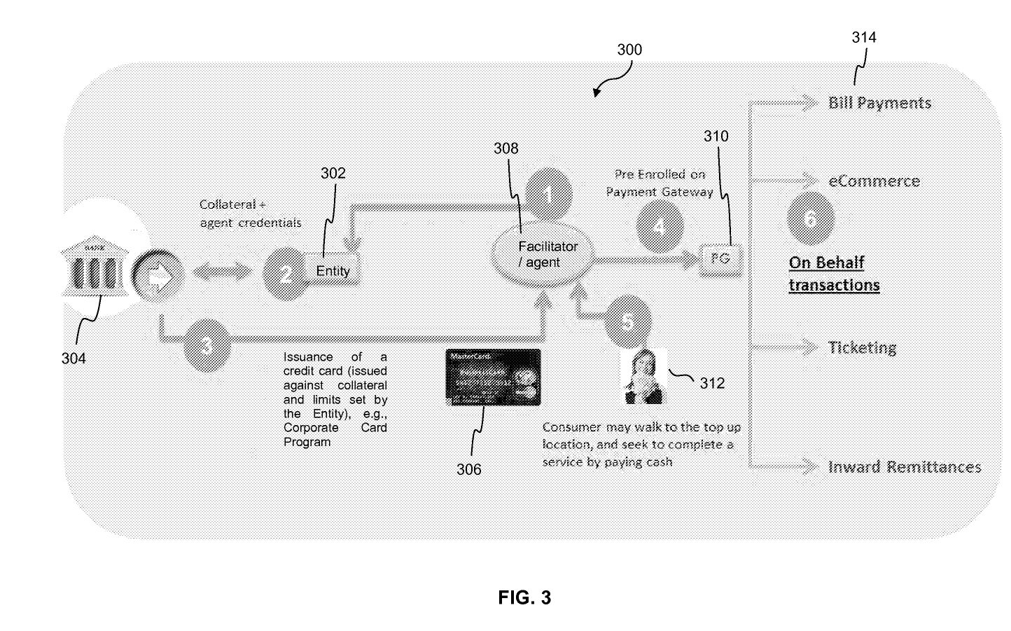

An exemplary overview of the inter-relationship between various parties involved in the on-behalf electronic payment transaction (payment program) 300 according to an embodiment of the present disclosure is shown in FIG. 3. The entity 302 (e.g., company/organization) applies for payment cards 306 from the issuer bank 304 to be issued under its name for use by the facilitators/agents 308 of its distribution network. That is, the payment cards 306 are issued based on terms and conditions agreed between the entity 302 and the issuer bank 304, such as, collateral and limits set by the entity 302, e.g., a corporate card program. It will be appreciated to a person skilled in the art that the issuer bank 304 may simply issue and provide the entity with payment card accounts without necessarily providing physical payment cards. Once the payment card account is enrolled on the payment gateway 310 by the issuer bank 304, the facilitator/agent 308 (equipped with the payment application on a mobile device 206 having the account of the payment card 306 linked thereto), is able to conduct on-behalf transaction for a customer 312 seeking to make cash payments. As shown in FIG. 3, the customer 312 may visit the facilitator 308 to make cash payments for a variety of merchant's goods and services 314.

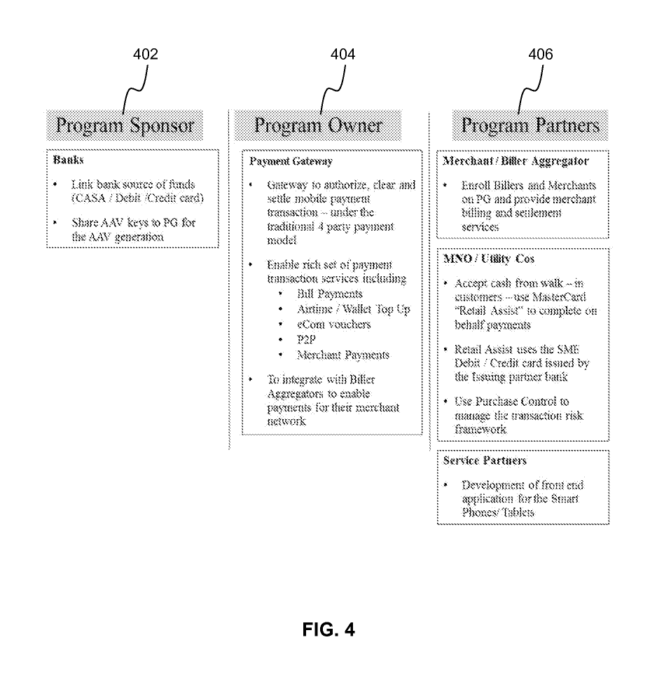

According to an embodiment of the present disclosure, various parties involved in the payment program may be broadly categorized into three main groups as shown in FIG. 4, namely, the program sponsor 402, the program owner 404, and the program partners 406. The program sponsor 402 includes, e.g., the issuer and acquirer financial institutions 210, 214 as described hereinbefore. The program owner 404 is preferably a company that issues and manages/owns the payment application and manages/owns the payment gateway 208 (such as the MasterCard Payment Gateway operated by MasterCard International Incorporated) to authorize, clear and settle the payment transaction. The program partners 406 include merchants who are enrolled as billers with the program owner 404 to receive payments through the payment application, and entities 302/facilitators/agents 308 who conduct the on-behalf electronic payment transaction using the payment application. The program partners 406 may also include software developers for the development of the mobile applications, such as the payment application for the mobile device 100.

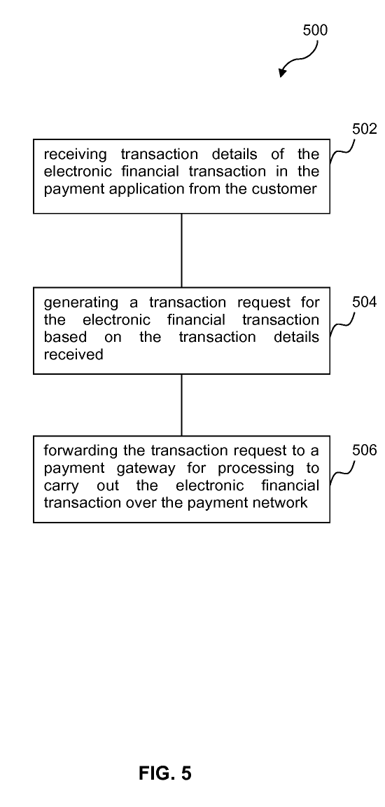

A method 500 of conducting an electronic financial transaction over a payment network 212 on behalf of a customer 202 using a payment application stored in a mobile device 206 of a facilitator 204 will now be described according to an exemplary embodiment with reference to FIG. 5. As a first step 502, transaction details of the electronic financial transaction are received in the payment application the customer 202. For example, in the case of the electronic financial transaction being a payment transaction according to the first embodiment, the facilitator 204 receives the details of the item from the customer and inputs them into the payment application of the mobile device 206. On the other hand, in the case of the electronic financial transaction being a funding transaction for a funds transfer according to the second embodiment, the facilitator 204 receives details of the recipient/beneficiary and inputs them into the payment application of the mobile device 206. Subsequently, in step 504, a transaction request for the electronic financial transaction is generated based on the transaction details received. For example, the mobile device 206, under the control of the payment application when executed, is operable to generate the transaction request for the electronic financial transaction based on the transaction details received. In step 506, the transaction request is forwarded to the payment gateway 208 for processing to carry out the electronic financial transaction over the payment network 212. In an embodiment, prior to the payment gateway 208 executing the transaction request, the mobile device 206 prompts the facilitator 204 to input an authentication code (e.g., PIN) and the received authentication code is forwarded to the payment gateway 208 for verifying the identity of the facilitator 204. As described hereinbefore, the payment gateway 208 has stored therein account details of a payment card linked to the facilitator 204 from which funds are authorized to be deducted (e.g., in the case of a payment transaction or a funds transfer) or to which funds are authorized to be credited (e.g., in the case of a cash-out transaction) to pay for or receive funds from the electronic financial transaction on behalf of the client in exchange for the facilitator 204 receiving cash payment from or providing cash to the customer 202.

It will be appreciated by a person skilled in the art that inputting/entering the transaction details into the payment application by the facilitator 204 does not necessarily involve the facilitator 204 keying in the details manually. For example, the bill provided by the customer 202 may have an electronic code (e.g., a bar code or QR code) such that the facilitator 204 simply has to scan the electronic code to obtain the necessary transaction details that will then be automatically populated in the payment application. For example, the mobile device 206 may have an image sensor (e.g., in the form of a camera) capable of reading the electronic code and transmitting the captured data to the payment application for processing.

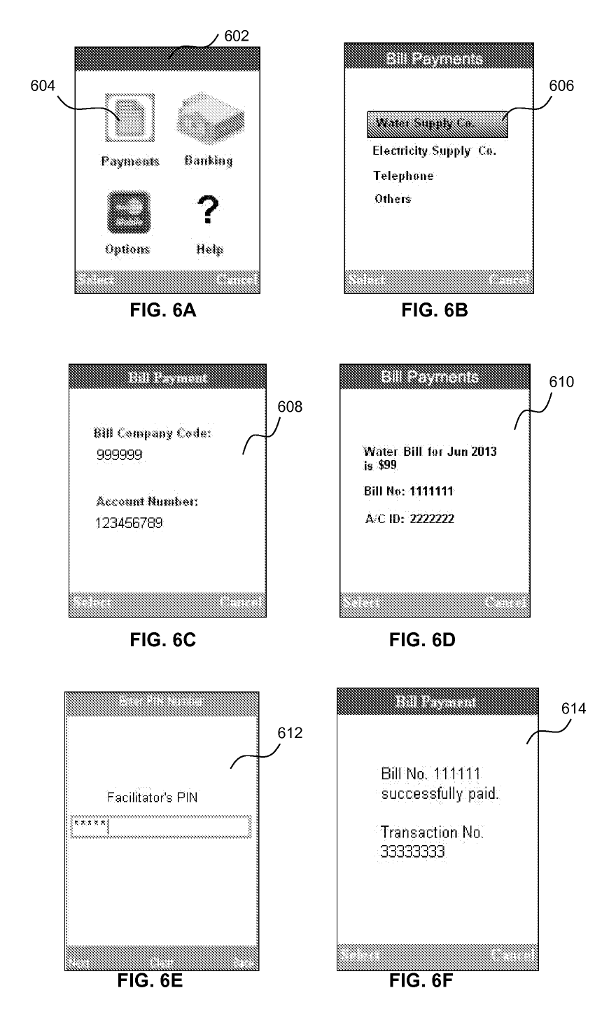

An illustrative example of conducting a bill payment will now be described with reference to FIGS. 6A to 6F according to an embodiment of the present disclosure. FIGS. 6A to 6F shows the user interface of the payment application displayed at various stages of the payment transaction. FIG. 6A depicts an exemplary start/home screen 602 of the payment application providing the facilitator 204 with various options including a payment option 604 for making on-behalf payment according to exemplary embodiments of the present disclosure. In this example, the customer 202 wishes to make cash payment for his/her water bill.

As a first step, the customer 202 provides the facilitator 204 with details of the desired transaction (i.e., water supply company name, account or bill number and payment amount). At this stage, the facilitator 204 may also obtain the customer's 202 mobile number and/or e-mail address for sending the transaction confirmation thereto upon completion. Based on the transaction details provided, the facilitator 204 proceeds to select the water supply company 606 displayed by the payment application as an available biller shown in FIG. 6B. FIG. 6C shows the biller details displayed on the screen 608 for confirmation/verification. Once the biller is confirmed to be correct, the payment application proceeds to the data entry screen 610 as shown in FIG. 6D where the facilitator 204 enters the necessary transaction details (e.g., account or bill number and payment amount) for the payment. Thereafter, the payment application is operable to display an authentication screen 612 for prompting the facilitator 204 to enter his/her authentication code as shown in FIG. 6E. The authentication code entered is verified by the payment gateway 208 and if correct, a payment authorization request is created based on the transaction details provided and forwarded to the acquirer 210 for processing as described hereinbefore. The payment gateway 208 is operable to receive the issuer response indicating whether the payment authorization request is approved, and in turn, communicates the issuer response to the mobile device 206 of the facilitator 204. An exemplary confirmation screen 614 displayed on the mobile device 206 is shown in FIG. 6F. After the payment transaction is successfully completed, the facilitator 204 collects cash payment from the customer 202 to cover for the cost of the item, along with any service fees.

It will be appreciated to a person skilled in the art that the above example of paying a water bill is merely for illustration purposes only and the customer 202 may pay any type of merchants (e.g., telephone companies, insurance companies, remittance services, online merchants, etc.) as long as the merchant is enrolled with the payment program and appears as a biller in the payment application for accepting payment.

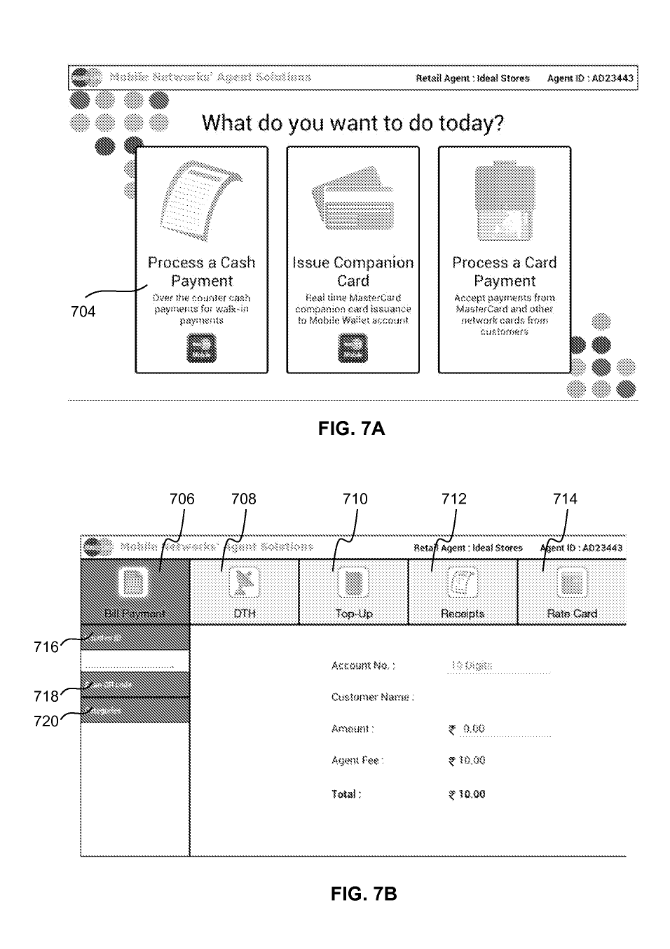

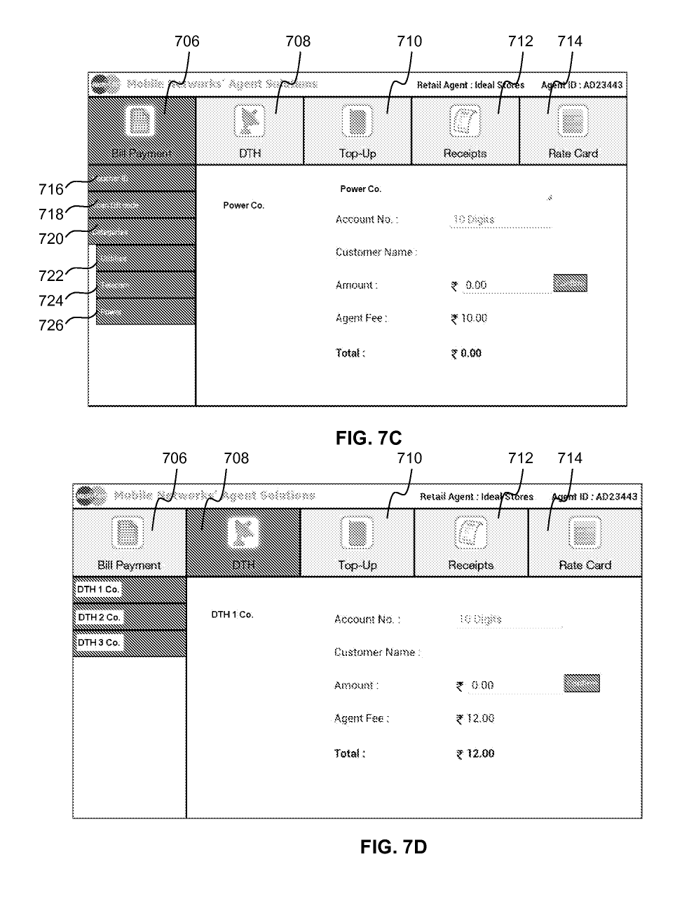

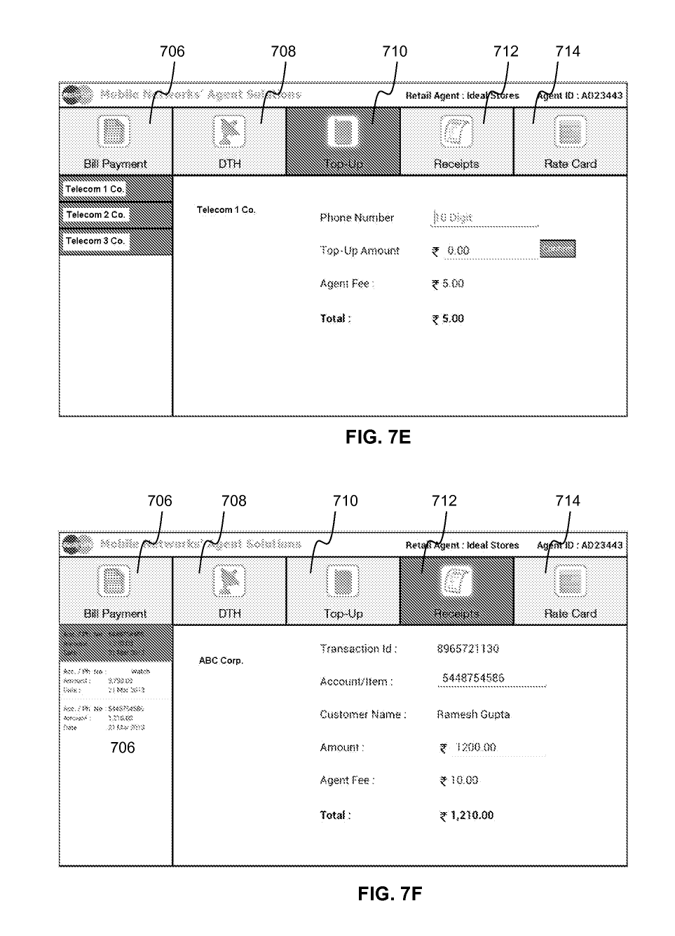

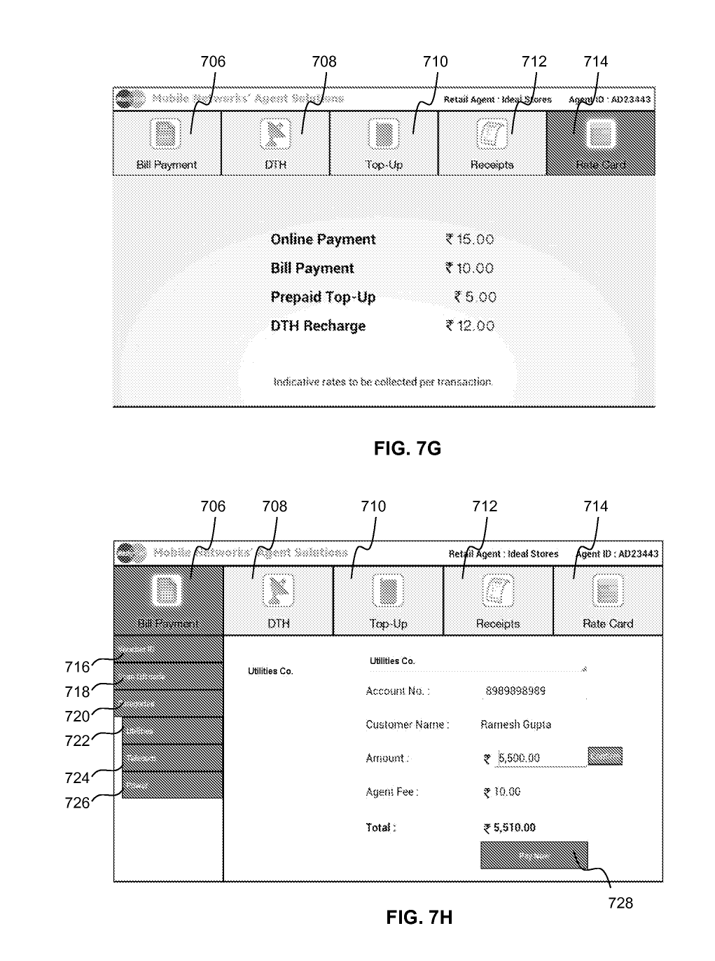

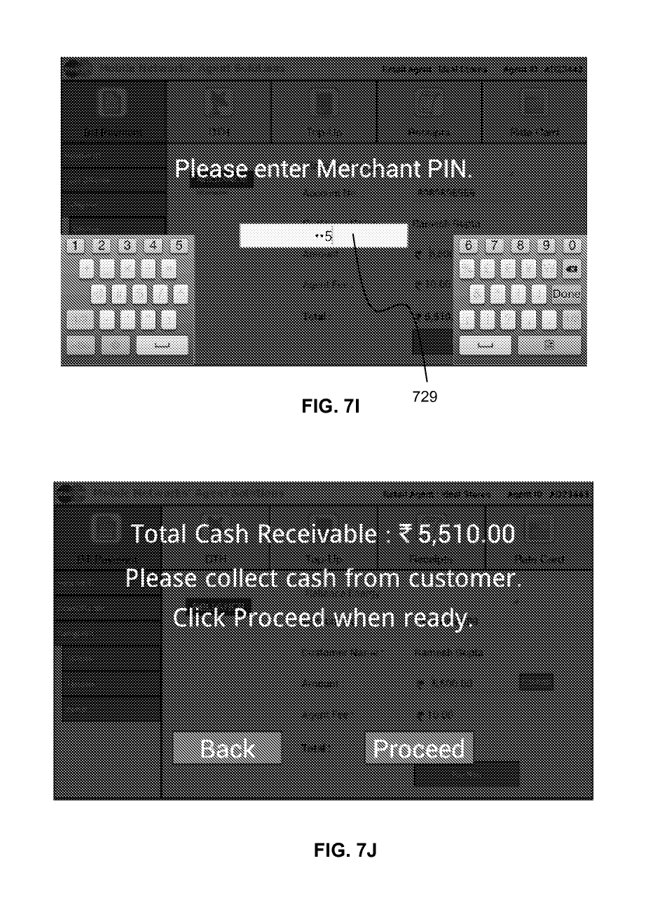

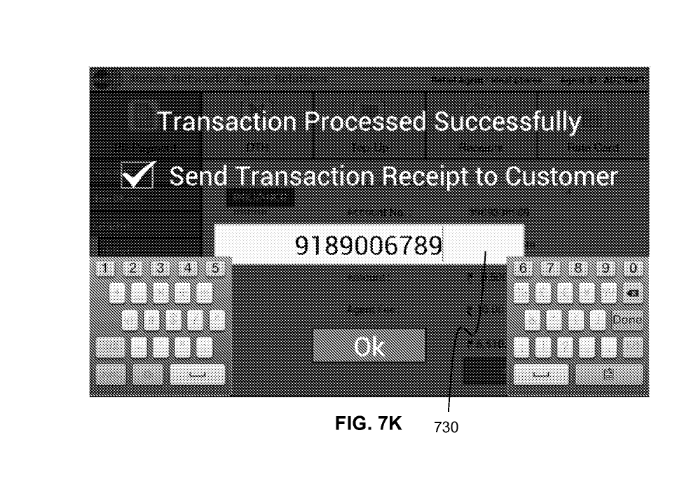

Furthermore, it will be appreciated to a person skilled in the art that the user interface may be presented in various other formats and is not limited to those shown in FIGS. 6A to 6F. For example, the user interface may instead be presented in the format as shown in FIGS. 7A to 7K described below.

FIG. 7A depicts an exemplary start/home screen of the payment application providing the facilitator 204 with various options including a payment option 704 for making on-behalf payment according to exemplary embodiments of the present disclosure. FIG. 7B depicts a user interface displayed after initiating the payment option 704 and shows the various types of payment services available. For example, according to an embodiment, the types of payment services include bill payment 706, Direct-To-Home television (DTH) payment 708, mobile top-up payment 710, receipt payment 712 and rate card payment 714. FIGS. 7C, 7D, 7E and 7F respectively illustrate the exemplary data entry screens for each of the above types of payment services where the necessary transaction details are entered. For example, as shown in FIG. 7C, the bill payment option 706 may provide a voucher ID option 716 for receiving a reference number to obtain the necessary transaction details for conducting the payment transaction, a QR code option 718 for capturing a QR code to obtain the necessary transaction details, and a category 720 of billers/merchants enrolled in the payment program, such as utilities 722, telecom 724 and power 726. FIGS. 7D, 7E and 7F illustrate different aspects of the data entry screens. FIG. 7G illustrates an exemplary summary screen. FIG. 7H illustrates an exemplary completed data entry screen in the case where the customer is paying a power bill. After confirming that the transaction details entered are correct (e.g., by pressing the “Pay Now” button 728), the payment application is operable to prompt the facilitator 204 to enter his/her authentication code in an input field 729 as shown in FIG. 7I. Once authenticated, as shown in FIG. 7J, the payment application may prompt the facilitator 204 to collect cash payment from the customer 202. After receiving the payment, the facilitator 204 can proceed to initiate the transaction request. FIG. 7K illustrates an exemplary confirmation screen confirming that the transaction request has been successful and providing an input field 730 for receiving contact information (e.g., an e-mail address or a phone number) for forwarding the transaction confirmation thereto.

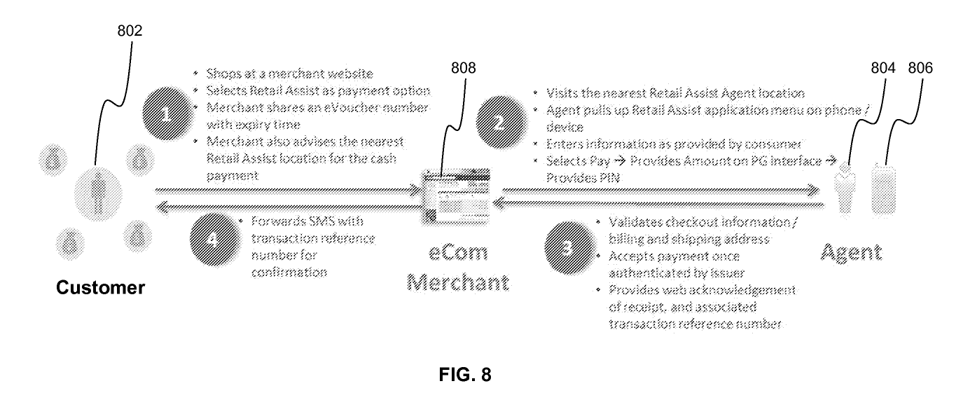

An illustrative example of conducting an electronic payment transaction with an online merchant (or e-Commerce merchant) will now be described with reference to FIG. 8 according to an embodiment of the present disclosure.

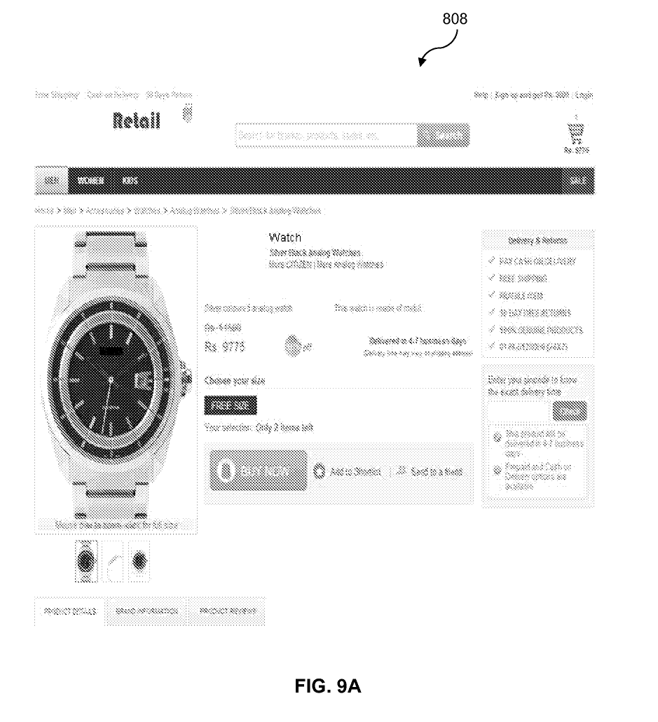

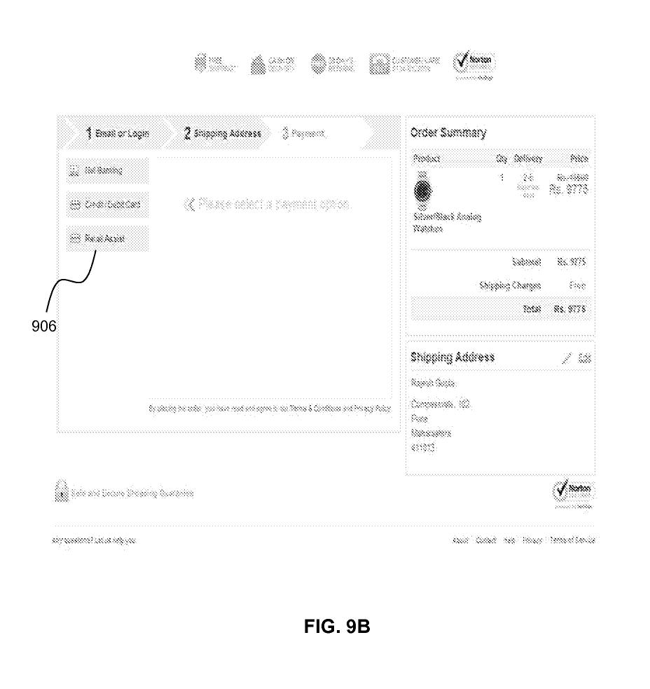

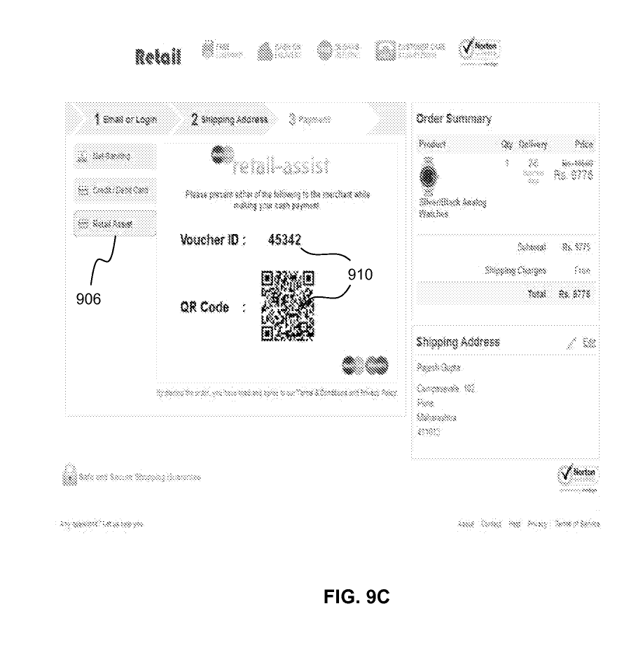

In this example, the customer 802 may wish to purchase an item from a merchant's website 808 using cash for various reasons such as not having or not comfortable with using a credit/debit card. For illustration purpose only, an exemplary merchant's website 808 is shown in FIG. 9A. In this example, the merchant is enrolled with the payment program as described hereinbefore (in this example, called “Retail Assist” and also as described under Program Partners 406 in FIG. 4) and thus provides the option of accepting payment via the payment application. To inform customers 802 of the availability of Retail Assist, the merchant's website 808 may display the Retail Assist acceptance mark (not shown). After the customer 802 has completed selecting the item(s) he/she wishes to purchase, the customer 802 checks out using the Retail Assist option 906. FIG. 9B illustrates an exemplary payment page providing various payment options, including the Retail Assist option 906. With the Retail Assist option 906, upon completing the checkout process, the merchant's website 808 will issue the customer 802 with a payment voucher which the customer 802 may then provide to the facilitator 804 to conduct an electronic payment to the merchant on behalf of the customer 802. For example, the payment voucher indicates information necessary for the customer 802 to make the payment, such as the merchant's name, the merchant's account number and the invoiced amount. The payment voucher may be in the form of an electronic document (e.g., Word document, PDF, SMS message, etc.) containing the above information or may be in the form of an electronic code 910 (e.g., an e-voucher reference number and/or a QR code) as shown in FIG. 9C whereby the information is linked therewith or embedded therein. Preferably, the payment voucher also includes an expiry date (i.e., a date which the payment must be made before the purchase is cancelled).

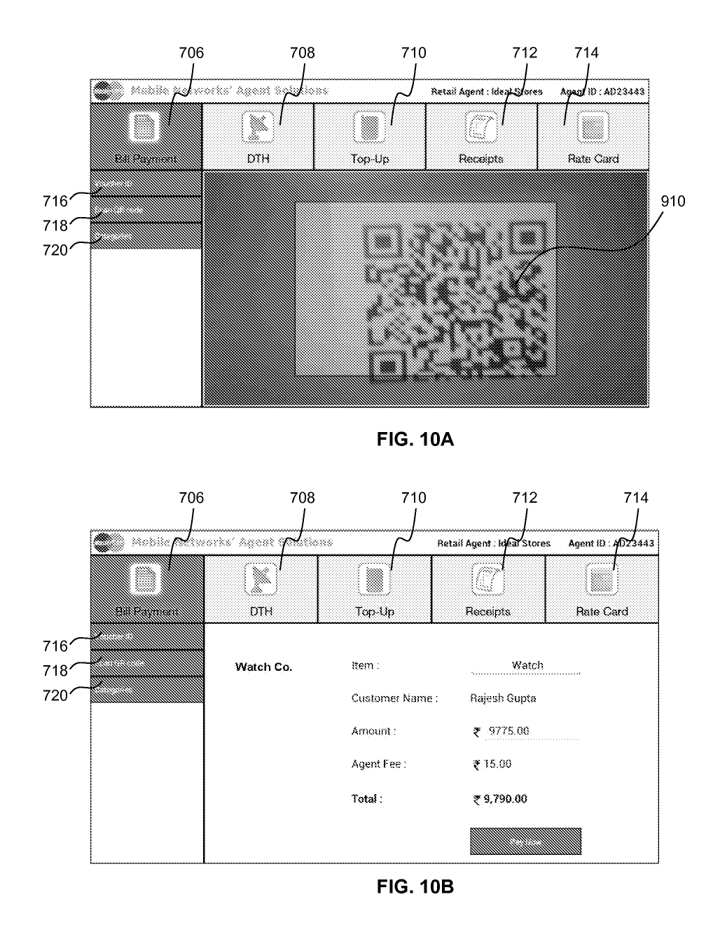

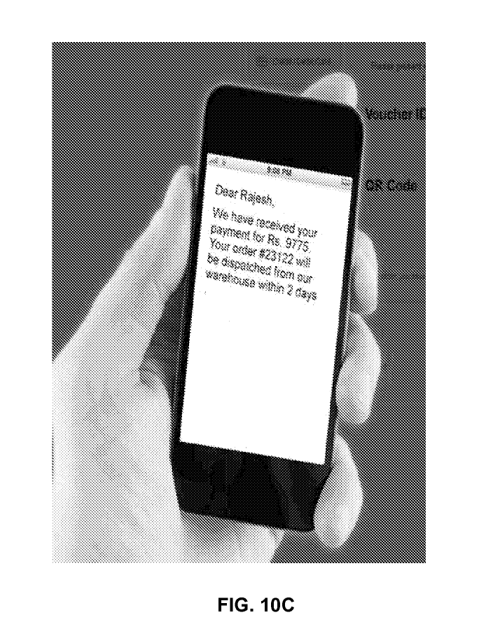

With the payment voucher, the customer 802 visits the facilitator 804 to make cash payment for his/her purchase. Transaction details necessary for the payment transaction are obtained from the payment voucher. For example, the facilitator 804 and/or the customer 802 may enter the necessary transaction details into the payment application residing on the facilitator's 804 mobile device 806. Alternatively, as shown in FIG. 10A, the customer 802 may present a QR code 910 to the facilitator 804 for scanning so as to transfer the necessary transaction details into the payment application. FIG. 10B illustrates an exemplary page displaying the transaction details for verification/confirmation. Once the transaction details are confirmed to be correct, the payment application then processes the transaction details to conduct the payment transaction in the same or similar manner as described hereinbefore and need not be repeated for clarity and conciseness. Once the payment authorization request is approved by the issuer bank 214, the merchant and the customer 802 are informed of the successful transaction and the merchant can then release the item purchased to the customer 802. For example, FIG. 10C illustrates an exemplary confirmation message that the payment has been received and the purchased item will be dispatched.

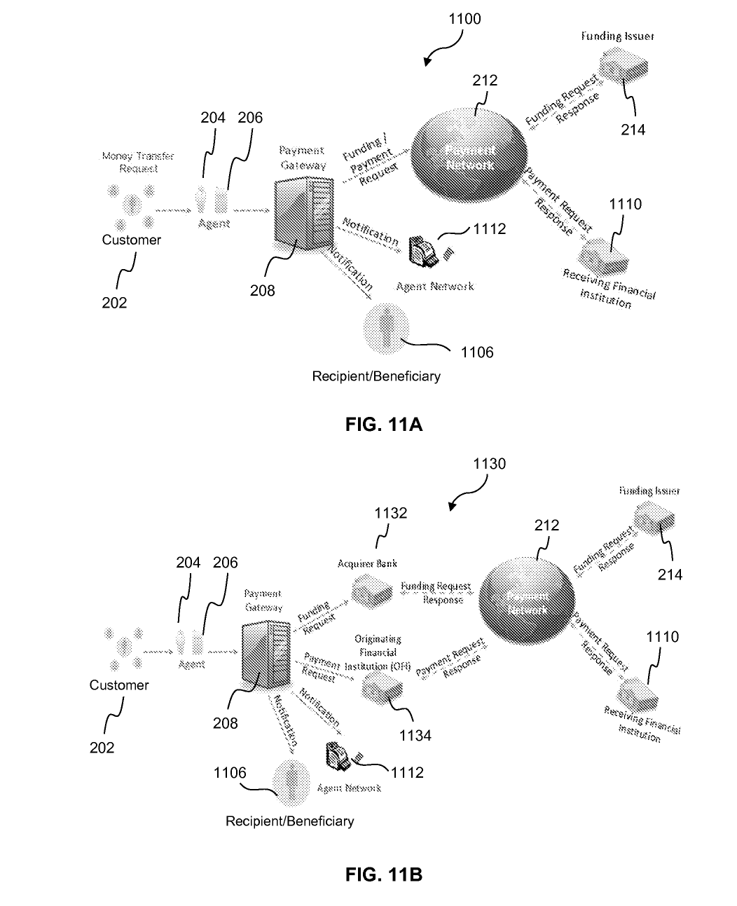

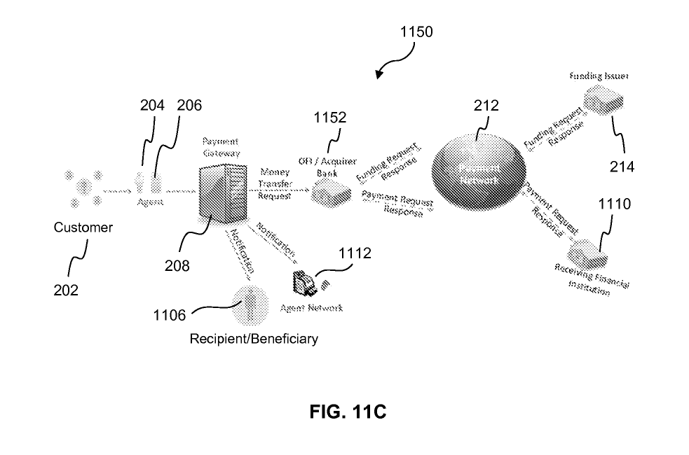

The second embodiment of the present disclosure will now be described for the case where the electronic financial transaction is a funding transaction. FIG. 11A generally illustrates a broad overview of an electronic funding transaction system 1100 for conducting a funding transaction on behalf of a customer 202 according to the second embodiment of the present disclosure. Components of the system 1100 are the same as, or similar to, those described in the first embodiment where the electronic financial transaction is a payment transaction are denoted by the same reference numbers, and may have the same/similar construction and functions, unless otherwise specified.

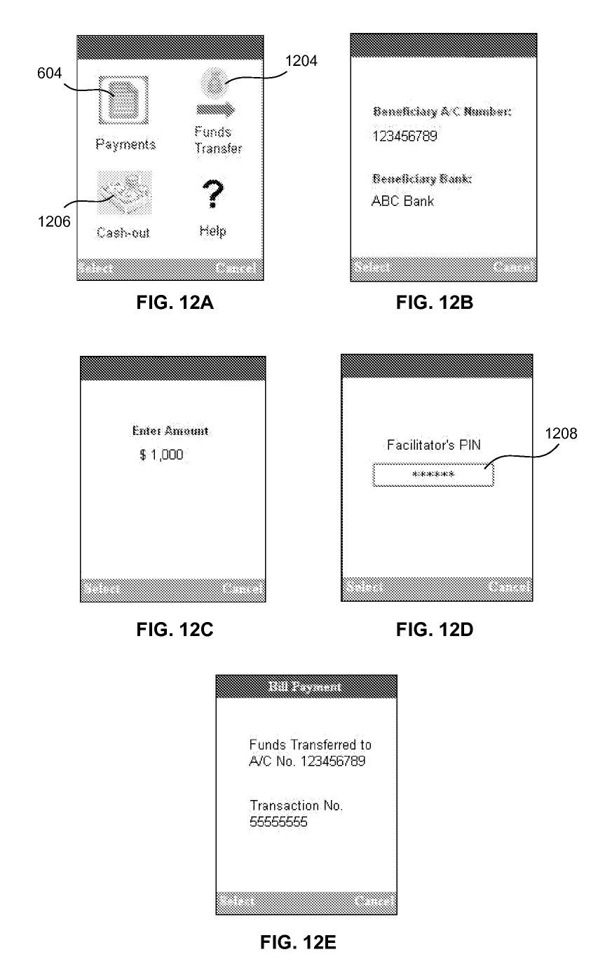

In an embodiment, the electronic funding transaction is a funds transfer from a customer 202 to a recipient/beneficiary 1106. To make the funds transfer, the customer 202 visits a facilitator (e.g., an agent) 204 who is able to conduct the on-behalf electronic funding transaction. In particular, the facilitator 204 is equipped with a mobile device 206 having a payment application installed therein capable of processing the electronic funding transaction. As an example, the user interface of the payment application displayed at various stages of the funding transaction is shown in FIGS. 12A to 12E.

The payment application may be configured to display various options including a payment option 604 for making on-behalf payment, a funds transfer option 1204 and a cash-out option 1206 as illustrated in FIG. 12A. After the funds transfer option 1204 is selected, the payment application may be configured to prompt the facilitator 204 to enter the necessary transaction details to conduct the funding transaction. The facilitator 204 receives the transaction details from the customer 202 and enters them in the payment application as illustrated in FIGS. 12B and 12C. For example, the transaction details required may include an identifier of the recipient/beneficiary 1106 (e.g., phone number, e-mail address, social network ID, account number, credit/debit/prepaid card number, bank name, etc.) and a transfer amount. The funding transaction may require further details, such as the personal particulars of the customer 202 and the recipient 1106 (e.g., name, national ID, residential address, etc.) for verification and due diligence check.

After inputting the transaction details, the payment application is configured to prompt the facilitator 204 to enter an authentication code (e.g., a PIN) in an input field 1208 as illustrated in FIG. 12D for authentication with the payment gateway 208. In this regard, the payment application encrypts and sends the authentication code and the received transaction details to the payment gateway 208 in the form of a funding transaction request for validation and further processing. FIG. 12E illustrates a confirmation screen.

If the payment gateway 208 successfully authenticates the facilitator 204, the payment gateway 208 executes/processes the funding transaction request received. In particular, the payment gateway 208 generates a funding authorization request and sends the funding authorization request to the funding issuer 214 associated with the facilitator's 204 account for authorization via a payment network 212. In this regard, the payment gateway 208 is operable to map the identifier of the recipient/beneficiary 1106 to an account of the recipient/beneficiary 1106 (e.g., credit/debit/prepaid card account) for which the funds are to be credited. The funding authorization request is generated against the account of the facilitator 204 (e.g., credit/debit/prepaid card account) linked to the payment application processing the funding transaction on behalf of the customer 202. In response, the funding issuer 214 generates an issuer response indicating whether the funding authorization request has been approved and forwards the issuer response to the payment gateway 208 via the payment network 212. If approved, the payment gateway 208 is configured to generate and send, via the payment network 212, a payment authorization request to the receiving financial institution (RFI) 1110 associated with the account of the recipient linked to the recipient identifier. Based on the payment authorization request, the RFI 1110 authorizes the payment transaction and returns an authorization response to the payment gateway 208 via the payment network 212. The payment gateway 208 may then send a transaction notification to the facilitator 204 and/or the customer 202 to confirm that the transaction has been successful. The recipient/beneficiary 1106 may also be notified of the funds transfer by the payment gateway 208 or the RFI 1110. For example, the notification can be in the form of a mobile message (e.g., SMS) or an e-mail.

Alternatively, instead of transferring the funds to an account of the recipient (i.e., credit/debit/prepaid card), the funds may be transferred to an account of a facilitator 204 in the agent network 1112 from which the recipient/beneficiary 1106 may collect the funds in cash. For example, this can be because the recipient/beneficiary 1106 is unbanked or does not have an account suitable for receiving the funds.

It will be appreciated to a person skilled in the art that the user interface shown in FIGS. 12A to 12E may be presented in various other formats. Furthermore, it will be appreciated to a person skilled in the art that the transaction flow for the funds transfer is not limited to that shown in FIG. 11A, and that the transaction flow may have other configurations as appropriate. For example, FIGS. 11B and 11C illustrate two other exemplary configurations for the transaction flows according to embodiments of the present disclosure.

The electronic funding transaction system 1130 shown in FIG. 11B is the same as the system shown in FIG. 11A except for the addition of an acquirer bank 1132 and an originating financial institution (OFI) 1134 between the payment gateway 208 and the payment network 212. With this configuration, the payment gateway 208 sends the funding authorization request to the acquirer bank 1132 for authorization, clearing and settlement with the funding issuer 214 via the payment network 212. Furthermore, after the funding authorization request has been approved, the payment gateway 208 sends the payment authorization request to the OFI 1134 for authorization, clearing and settlement with the RFI 1110 via the payment network 212.

The electronic funding transaction system 1150 shown in FIG. 11C is the same as the system shown in FIG. 11B except that the acquirer 1132 and the OFI 1134 are under the same entity 1152 (i.e., the same financial institution).

Preferably, the payment gateway 208 is operable to send a transaction reconciliation file to the acquirer 1132 and the OFI 1134. The acquirer 1132 may send the clearing records to the funding issuer 214 via the payment network 212 for posting to the facilitator's 204 account statement, and the OFI 1134 may also send the clearing records to the RFI 1110 via the payment network 212 for posting to the recipient's account statement.

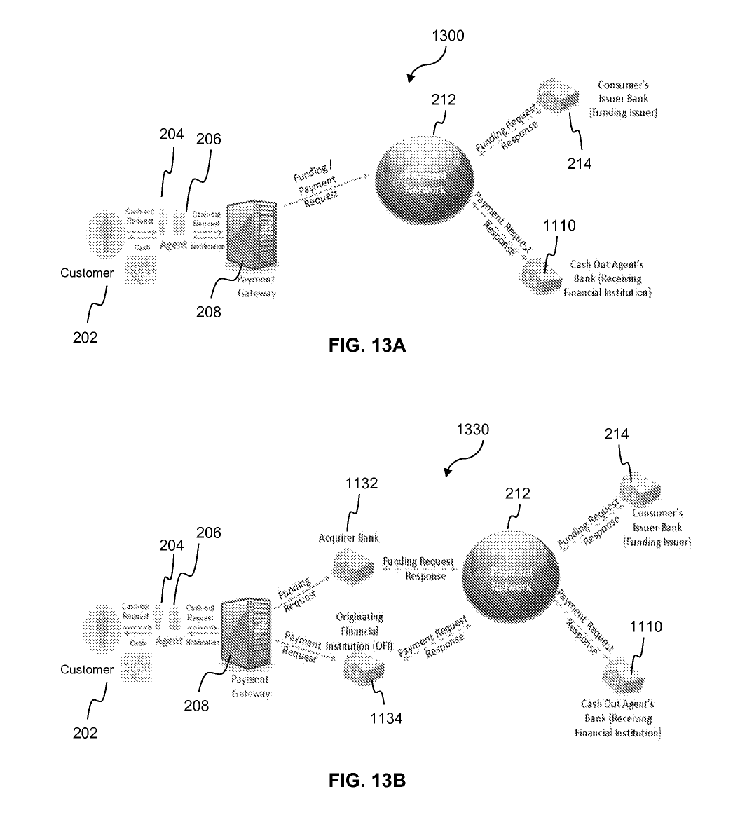

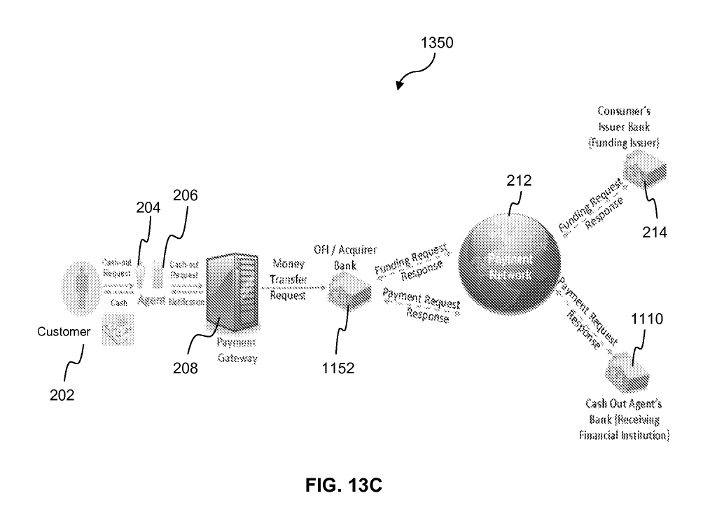

In another embodiment, the electronic funding transaction is a cash-out transaction by a customer 202 at a facilitator's 204 location. In this case, the customer 202 has an account (e.g., credit/debit/prepaid account) from which he/she would like to withdraw funds. FIG. 13A generally illustrates a broad overview of an electronic funding transaction system 1300 for conducting a cash-out transaction for the customer 202. As can be seen from FIG. 13A, the transaction flow for the cash-out transaction is generally the same as the transaction flow for the funds transfer transaction, except that the customer 202 is requesting a cash-out and thus the beneficiary is the customer himself/herself. Accordingly, in this case, the funding authorization request will be generated and sent to the funding issuer 214 associated with the account of the customer 202, and the payment authorization request will be generated and sent to the RFI 1110 associated with the account of the facilitator 204 that is linked to the payment application processing the cash-out transaction on behalf of the customer 202. Therefore, the account of the facilitator 204 can be authorized to be credited based on the transaction request (i.e., cash-out transaction) to receive the requested funds from the electronic funding transaction on behalf of the customer 202 in exchange for the facilitator 204 providing the requested cash to the customer 202.

In this embodiment, the payment application is configured to display a cash-out option 1206 as illustrated in FIG. 12A. After the cash-out option 1206 is selected by the facilitator 204, the payment application is configured to prompt the facilitator 204 to enter the necessary transaction details to conduct the cash-out transaction. For example, the transaction details required may include an identifier of the customer 202 (e.g., phone number, e-mail address, social network ID, account number, credit/debit/prepaid card number, bank name, etc.) and a cash-out amount. The cash-out transaction may require further details, such as the personal particulars of the customer 202 (e.g., name, national ID, residential address, etc.) for verification. Alternatively, the customer 202 can enter the necessary transaction details in the payment application to conduct the cash-out transaction initiated by the customer 202.

After inputting the transaction details, the payment application is configured to prompt the facilitator 204 to enter an authentication code (e.g., a PIN) for authentication with the payment gateway 208 in the same manner as described hereinbefore. After the facilitator 204 has been authenticated, the payment application is configured to send a cash-out transaction request to the payment gateway 208, which will then be processed in generally the same manner described hereinbefore to obtain the funds, with the exception that (as explained above) the funding authorization request generated by the payment gateway 208 will be forwarded to the funding issuer 214 associated with the account of the customer 202, and the payment authorization request generated by the payment gateway 208 will be forwarded to the RFI 1110 associated with the account of the facilitator 204 linked to the payment application processing the cash-out transaction on behalf of the customer 202. If the identifier provided by the customer 202 is not his/her account details (e.g., phone number, e-mail address, etc.), the payment gateway 208 is configured to map the identifier to an account of the customer 202 from which funds are to be withdrawn. In this regard, for example, the payment gateway 208 may have stored therein a predetermined account selected by the customer that is linked to the identifier.

In this embodiment, since a cash-out transaction is conducted, it will be necessary to authenticate the identity of the customer 202 to establish that the customer 202 is the owner of the account. For example, this may be achieved by way of visual inspection of the credit/debit/prepaid card along with an authorized signature or an authorized code (e.g., PIN) for the credit/debit/prepaid card which is required to be entered. Alternatively, the customer 202 may be authenticated via a challenge/response using variety of methods such as IVR, SMS, payment application, etc.

It will be appreciated to a person skilled in the art that the transaction flow for the cash-out transaction is not limited to that shown in FIG. 13A, and that the transaction flow may have other configurations as appropriate. For example, FIGS. 13B and 13C illustrate other exemplary configurations for the transaction flow. FIG. 13B illustrates a system 1330 with the addition of an acquirer bank 1132 and an OFI 1134 between the payment gateway 208 and the payment network 212, and FIG. 13C illustrates a system 1350 for the case where the acquirer bank 1132 and the OFI 1134 are under the same entity 1152 in the same manner as described with respect to FIGS. 11B and 11C.

According to an exemplary embodiment, there is provided a system 250 (see FIG. 2) for conducting on-behalf electronic financial transaction comprising a mobile device 206 having a payment application installed therein, and a payment gateway 208. The mobile device 206, having the payment application, and the payment gateway 208 have been described in detail hereinbefore and thus will not be repeated for clarity and conciseness. For example, the system 250 is operable to receive transaction details of the electronic financial transaction from a customer 202 wishing to use cash. Based on the transaction details received, the system 250 is operable to create and forward a payment authorization request to the acquirer 210 for further processing downstream in the manner as described hereinbefore involving the payment network 212 and issuer bank 214. The system 250 is operable to receive the issuer response generated by the issuer bank 214 indicating whether the payment authorization request has been approved, and generates a transaction receipt (e.g., in the form of a printed receipt or an electronic receipt sent via text or e-mail) for the customer 202 indicative of the output of the payment transaction request.

As described hereinbefore, the payment application may be supplied to the mobile device 100 embodied in a non-transitory computer-readable storage medium, i.e., a computer program product. With current state-of-the-art smartphones, mobile applications are typically downloaded onto the computer-readable data storage medium 128 of the mobile device 100 wirelessly through digital distribution platforms, such as iOS App Store and Android Google Play. After the payment application is installed in the mobile device 100, the payment application is executable by the processor 116 of the mobile device 100 to perform the method of conducting on-behalf electronic financial transaction according to exemplary embodiments as described hereinbefore.

The example embodiment advantageously creates an open and interoperable mobile payment ecosystem involving various parties, such as the program sponsor 402, the program owner 404 and the program partners 406. The example embodiment provides a scalable model and reduces the costs of onboarding new billers for the network participants (e.g., MNO). In particular, it is not necessary for the network participants to individually enter into bilateral agreements with each new biller to offer the payment service since the biller network (i.e., available billers) are managed by, e.g., the biller aggregator and provided via the payment application. The exemplary embodiment provides an opportunity for the merchants to make additional revenues by monetizing its agent network by offering payment collection services on behalf of other merchants through the payment application and charging an appropriate service fee. Furthermore, the exemplary embodiment provides an effective solution of collecting payments in markets with significant unbanked by advantageously converting unbanked bill payments to payment card transactions.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects to be illustrative and not restrictive.

1. A method of conducting an electronic financial transaction over a payment network on behalf of a customer using a payment application stored in a mobile device of a facilitator, the method comprising:
receiving transaction details of the electronic financial transaction in the payment application from the customer;
generating a transaction request for the electronic financial transaction based on the transaction details received; and
forwarding the transaction request to a payment gateway for processing to carry out the electronic financial transaction over the payment network, the payment gateway having stored therein account details of a payment card linked to the facilitator from which funds are authorized to be deducted or to which funds are authorized to be credited based on the transaction request to pay for or receive funds from the electronic financial transaction on behalf of the customer in exchange for the facilitator receiving cash payment from or providing cash to the customer.

2. The method according to claim 1, further comprising:
receiving an authentication code from the facilitator, and
forwarding the authentication code to the payment gateway for verifying the identity of the facilitator prior to the payment gateway executing the transaction request,
wherein the payment gateway having further stored therein a predetermined authentication code linked to the payment application for verification against the received authentication code.

3. The method according to claim 2, wherein the authentication code is a personal identification number (PIN) of the facilitator.

4. The method according to claim 1, wherein the payment card is a debit card, a credit card or a prepaid card, and the account details linked to the facilitator comprise a debit card number, a credit card number or a prepaid card number and an expiry date.

5. The method according to claim 1, wherein the electronic financial transaction comprises a payment transaction on behalf of the customer for an item of goods and/or services, and the transaction details received comprise details of the item of goods and/or services.

6. The method according to claim 5, wherein said details of the item comprise information indicative of a biller or a merchant of the item and a payment amount.

7. The method according to claim 5, wherein the payment application is operable to provide a list of participating billers and/or merchants for accepting payments through the payment application.

8. The method according to claim 5, wherein a plurality of the payment cards is issued for an entity managing or owning a distribution network comprising a plurality of the facilitators, each facilitator being respectively linked with account details of a unique one of the plurality of payment cards from which funds are authorized to be deducted to pay for the item on behalf of the customer in exchange for the facilitator receiving cash payment from the customer.

9. The method according to claim 8, wherein the entity is one of a telecommunications company, an insurance company, a post office, a ticketing company and a convenience store.

10. The method according to claim 5, wherein the item of goods and/or services is displayed on an online merchant's website, and the website is configured to provide a checkout option for accepting payment through the facilitator.

11. The method according to claim 10, wherein an acceptance mark is displayed on the website for informing the customer of the possibility of making payment through the facilitator.

12. The method according to claim 10, wherein upon checkout, the website is configured to provide the customer with a payment voucher comprising information indicative of said details of the item of goods and/or services to be supplied to the facilitator for conducting the electronic payment transaction, the payment voucher being in the form of an electronic document and/or an electronic code comprising said details of the item.

13. The method according to claim 1, wherein the electronic financial transaction comprises a funding transaction on behalf of the customer for a fund transfer from the customer to a recipient, and the transaction details received comprise details of the recipient and a transfer amount.

14. The method according to claim 1, wherein the electronic financial transaction comprises a funding transaction on behalf of the customer for a cash-out transaction, and the transaction details received comprise details of the customer and a cash-out amount.

15. A system for conducting an electronic financial transaction over a payment network on behalf of a customer, the system comprising:
a mobile device having stored therein a payment application for a facilitator to conduct the electronic financial transaction, the mobile device, under control of the payment application when executed, is operable to receive transaction details of the electronic financial transaction and generate a transaction request for the electronic financial transaction based on the transaction details received; and
a payment gateway operable to receive and process the transaction request, the payment gateway having stored therein account details of a payment card linked to the facilitator from which funds are authorized to be deducted or to which funds are authorized to be credited based on the transaction request to pay for or receive funds from the electronic financial transaction on behalf of the customer in exchange for the facilitator receiving cash payment from or providing cash to the customer.

16. The system according to claim 15, wherein the mobile device is operable to prompt the facilitator to input an authentication code, and forward the received authentication code to the payment gateway for verifying the identity of the facilitator prior to the payment gateway executing the transaction request, and
wherein the payment gateway is operable to store a predetermined authentication code linked to the payment application for verification against the received authentication code.

17. The system according to claim 15, wherein the authentication code is a personal identification number (PIN) of the facilitator.

18. The system according to claim 15, wherein the payment card is a debit card, a credit card, or a prepaid card, and the account details linked to the facilitator comprise a debit card number, a credit card number, or a prepaid card number, and an expiry date.

19. The system according to claim 15, wherein the electronic financial transaction comprises a payment transaction on behalf of the customer for an item of goods and/or services, and the transaction details received comprise details of the item of goods and/or services.

20. The system according to claim 15, wherein said details of the item comprise information indicative of a biller or a merchant of the item and a payment amount.

21. The system according to claim 15, wherein the mobile device is operable to provide a list of participating billers and/or merchants for accepting payments through the payment application.

22. The system according to claim 15, wherein a plurality of the payment cards is issued for an entity managing or owning a distribution network comprising a plurality of the facilitators, each facilitator being respectively linked with account details of a unique one of the plurality of payment cards from which funds are authorized to be deducted to pay for the item on behalf of the customer in exchange for cash payment from the customer.

23. The system according to claim 22, wherein the entity is one of a telecommunications company, an insurance company, a post office, a ticketing company and a convenience store.

24. The system according to claim 15, wherein the item of goods and/or services is displayed on an online merchant's website, and the website is configured to provide a checkout option to accept payment through the facilitator.

25. The system according to claim 24, wherein an acceptance mark is displayed on the website for informing the customer of the possibility of making payment through the facilitator.

26. The system according to claim 24, wherein upon checkout, the website is configured to provide the customer with a payment voucher comprising information indicative of said details of the item of goods and/or services to be supplied to the facilitator for conducting the electronic payment transaction, the payment voucher being in the form of an electronic document and/or an electronic code comprising said details of the item.

27. The system according to claim 15, wherein the electronic financial transaction comprises a funding transaction on behalf of the customer for a fund transfer from the customer to a recipient, and the transaction details received comprise details of the recipient and a transfer amount.

28. The method according to claim 15, wherein the electronic financial transaction comprises a funding transaction on behalf of the customer for a cash-out transaction, and the transaction details received comprise details of the customer and a cash-out amount.

29. A non-transitory computer readable medium encoded with computer executable instructions, which, when accessed, cause a machine to:
receive transaction details of an electronic financial transaction in a payment application from the customer;
generate a transaction request for the electronic financial transaction based on the transaction details received; and
forward the transaction request to a payment gateway for processing to carry out the electronic financial transaction over a payment network, the payment gateway having stored therein account details of a payment card linked to the facilitator from which funds are authorized to be deducted or to which funds are authorized to be credited based on the transaction request to pay for or receive funds from the electronic financial transaction on behalf of the customer in exchange for the facilitator receiving cash payment from or providing cash to the customer.
